(19) United States
(12) Patent Application Publication
(10) Pub. No.: US 2016/0153545 A1
(43) Pub. Date: Jun. 2, 2016

(54) PLANETARY GEAR SET AND METHOD FOR SUPPLYING OIL TO TOOTH ENGAGEMENT REGIONS AND BEARINGS OF A PLANETARY GEAR SET OF SAID TYPE

(71) Applicant: SIEMENS AKTIENGESELLSCHAFT, München (DE)

(72) Inventors: Ali Kemal KÜCÜKYAVUZ, Herne (DE); Frank KESCHTGES, Bocholt (DE)

(73) Assignee: SIEMENS AKTIENGESELLSCHAFT, 80333 München (DE)

(21) Appl. No.: 14/901,223

(22) PCT Filed: Jun. 25, 2014
(86) PCT No.: PCT/EP2014/063365

§ 371 Date: Dec. 28, 2015

(30) Foreign Application Priority Data
Jun. 27, 2013 (DE) 10 2013 212 464.3

(51) Int. Cl. F16H 57/04; F16H 1/46; F16H 1/28

(52) U.S. Cl. CPC F16H 57/0431; F16H 1/28; F16H 1/46; F16H 57/0486; F16H 57/0471; F16H 57/0479

(57) ABSTRACT

The invention relates to a planetary gear set (1) comprising a housing (2), a sun gear shaft (3) which is mounted rotatably in the housing (2) and which can be driven by means of a motor, a sun gear (6) which is held rotationally conjointly on the sun gear shaft (3), a planet gear carrier (7) which is mounted rotatably in the housing (2) and on which rotatably mounted planet gears (8) are held, wherein the planet gears (8) engage with the sun gear (6), an internal gear (11) which is arranged in positionally fixed fashion in the housing (2) and which has an internal toothing and which engages with the planet gears (8), a drive output flange which is operatively connected to the planet gear carrier (7) and which is mounted rotatably on the housing (2), and at least one oil supply which is designed to deliver oil to tooth engagement regions and/or bearings, wherein the oil supply comprises a sun gear shaft bore (20) which extends in the longitudinal direction of the sun gear shaft (3), a gap seal bushing (21) which is fluidically connected to the sun gear shaft bore (20), a planet gear carrier distributor (22) which is fluidically connected to the gap seal bushing (21) and which is provided on the planet gear carrier (7), and oil-conducting lines (23, 24) which are arranged on the planet gear carrier (7) and which are fluidically connected to the planet gear carrier distributor (22) and which lead to tooth engagement regions and/or bearings.

The present invention relates to a planetary gear set comprising a housing, a sun gear shaft which is mounted rotatably in the housing and which can be driven by means of a motor, a sun gear which is held in fixed rotative engagement on the sun gear shaft, a planet gear carrier which is mounted rotatably in the housing and on which rotatably mounted planet gears are held, wherein the planet gears engage with the sun gear, an internal gear which is arranged in positionally fixed fashion in the housing and which has an internal toothing and which engages with the planet gears, a drive output flange which is operatively connected to the planet gear carrier and which is mounted rotatably on the housing, and at least one oil supply which is designed to deliver oil to tooth engagement regions and/or bearings. The present invention further relates to a method for supplying oil to tooth engagement regions and bearing arrangements of a planetary gear set.

Such planetary gear sets are known from the prior art in all manner of configurations. In large mechanical structures, they may be used as e.g. gear sets for vertical mills which are used for crushing various materials such as e.g. minerals, limestone, brown coal, hard coal, raw materials for cement, etc. Vertical mills normally comprise a rotating horizontal grinding table, onto which the grinding tools that are held in a grinding bowl are pressed, and a planetary gear set of the type cited in the introduction which is arranged beneath the grinding table. The planetary gear set in a vertical mill is primarily responsible for the power transmission, the transformation of the required torque and rotational speed, the bearing arrangement of the grinding bowl and the absorption of milling forces.

The oil supply for the gear set is used to lubricate and cool the tooth engagement regions and the bearings, in order thus to ensure correct operation of the gear set and to reduce wear. As a result of the respective tooth engagement regions and bearings being a considerable distance apart, known oil supplies generally have a very complex structure. A plurality of oil supply runs are usually provided for lubrication of the tooth engagement regions alone, wherein the individual runs lead from a central distributor, which is immersed in an oil sump that is arranged in the lower region of the housing, to the individual tooth engagement regions.

Taking this prior art as its starting point, the object of the present invention is to provide a planetary gear set of the type cited in the introduction, which has a simple and inexpensive structure, and an alternative method for supplying oil to tooth engagement regions and bearing arrangements of a planetary gear set.

According to the present invention, this object is achieved by means of a planetary gear set of the type cited in the introduction, characterized in that the oil supply comprises a sun gear shaft bore which extends in the longitudinal direction of the sun gear shaft, a gap seal bushing which is fluidically connected to the sun gear shaft bore, a planet gear carrier distributor which is fluidically connected to the gap seal bushing and which, is provided on the planet gear carrier, and oil-conducting lines which are arranged on the planet gear carrier and which are fluidically connected to the planet gear carrier distributor and which lead to tooth engagement regions and/or bearings.

This structure of the oil supply for the planetary gear set according to the invention is advantageous in that oil which is pumped through the sun gear shaft bore initially arrives in the planet gear carrier distributor, from where it is led via the respective oil-conducting lines to the individual tooth engagement regions and/or bearings. In this case, the gap seal bushing forms the fluidical connection between the sun gear shaft and the planet gear carrier distributor, these rotating at different rotational speeds during operation.

According to an embodiment of the present invention, oil-conducting lines starting from the planet gear carrier distributor lead at least to a tooth engagement region between the internal gear and the planet gears, to a tooth engagement region between the sun gear and the planet gears, to the bearing of the planet gear carrier, and to the bearings of the planet gears. In other words, all bearings and engagement regions of the planetary stage are supplied with lubricating oil via the planet gear carrier distributor, i.e. via a single oil supply run.

The planet gear carrier distributor and/or at least part of the oil-conducting lines are advantageously so designed as to be integral with the planet gear carrier, thereby producing a simple structure having few individual parts. In particular, the planet gear carrier distributor and/or at least part of the oil-conducting lines are provided as bores which are introduced into the planet gear carrier, this being advantageous in terms of manufacturing.

According to an embodiment of the present invention, each of the oil-conducting lines leading to the bearings of the planet gears is connected to an oil reservoir which is provided in the form of a bore in particular, wherein the diameter of the bore of the at least one oil reservoir is so selected as to be greater than a diameter of an oil-conducting line. The oil reservoir/reservoirs are advantageously designed and arranged in such a way that oil emerges under the influence of gravity in the direction of the bearings and does not flow back in the direction of the sun gear shaft bore. This means that oil inlets of the oil reservoirs, being fluidically connected to the sun gear shaft bore, are preferably provided in the upper region of the oil reservoirs, and oil outlets of the oil reservoirs, being fluidically connected to the bearings, are preferably provided in the lower region of the oil reservoirs. By virtue of one or more such oil reservoirs, it is possible to guarantee the emergency running properties of the corresponding bearings.

According to a variant of the present invention, the drive output flange is connected in fixed rotative engagement to the planet gear carrier or is formed thereby. In this variant, the planetary gear set is designed as a single stage.

According to an alternative variant of the present invention, the planetary gear set is designed as a multi-stage planetary gear set and comprises a second sun gear shaft which is connected in fixed rotative engagement to the planet gear carrier, a second sun gear which is held in fixed rotative engagement on the second sun gear shaft, a second planet gear carrier which is mounted rotatably in the housing and to which rotatably mounted second planet gears that engage with the second sun gear are attached, and a second internal gear which is arranged in positionally fixed fashion in the housing and which has an internal toothing and which engages with the planet gears of the second planet gear carrier, wherein the drive output flange is connected in fixed rotative engagement to the second planet gear carrier or is formed thereby, and wherein the oil supply comprises a connection line which is fluidically connected to the planet gear carrier distributor that is provided on the first planet gear carrier, a second planet gear carrier distributor which is fluidically connected to the connection line and which is arranged on the second planet gear carrier, and oil-conducting lines which are arranged on the second planet gear carrier and which are fluidically connected to the second planet gear carrier distributor and which lead to tooth engagement regions and/or bearings.

This embodiment of the oil supply of the multi-stage planetary gear set is advantageous in that tooth engagement regions and/or bearings of both the first gear stage and the second gear stage are supplied with oil via a single oil supply run.

Starting from the second planet gear carrier distributor, the oil-conducting lines preferably lead at least to a tooth engagement region between the second internal gear and the second planet gears, to a tooth engagement region between the second sun gear and the second planet gears, and to the bearings of the second planet gears. In this way—with the exception of the bearing arrangement of the second planet gear carrier all tooth engagement regions and bearings of the second gear stage are supplied with the necessary lubricating oil via the oil supply. It is obviously possible in principle to include the bearing of the second planet gear carrier in the aforementioned oil supply. However, if the planetary gear set is a large-scale gear set, e.g. a vertical mill gear set, the bearing of the second planet gear carrier is preferably supplied with lubricating oil via a separate oil supply run of the oil supply.

The second planet gear carrier distributor and/or at least part of the oil-conducting lines arranged on the second planet gear carrier are advantageously so designed as to be integral with the second planet gear carrier, in particular as bores which are introduced into the second planet gear carrier. This results in a simple structure having few individual components.

Each of the oil-conducting lines leading to the bearings of the second planet gears is advantageously connected to an oil reservoir which is provided in the form of a bore in particular, wherein the diameter of the bore of the at least one oil reservoir is so selected as to be greater than a diameter of an oil-conducting line. By virtue of one or more such oil reservoirs, the emergency running properties of the corresponding bearings are guaranteed.

According to an embodiment of the present invention, the second sun gear shaft is so embodied as to be hollow, wherein the connection line is designed as a tube which is led through the second sun gear shaft, and wherein the tube is rotatably mounted on the second planet gear carrier by means of a bearing. In other words, the planet gear carrier of the first gear stage is suspended in a rotatably mounted manner on the second planet gear carrier of the second gear stage, thereby producing a simple structure.

The bearing is advantageously arranged within the second planet gear carrier distributor, such that an additional lubricating oil supply for the bearing is not required.

An annular gap below the bearing between the tube and the second planet gear carrier is preferably sealed by a sealing ring which is held on the tube, thereby reliably preventing any excessive leakage. The sealing ring is advantageously made of bronze, since such a bronze sealing ring has good sliding properties.

According to an embodiment of the present invention, spray devices are provided at the free end of the oil-conducting lines leading to the tooth engagement regions. Such spray devices ensure correct distribution of the lubricating oil which emerges from the oil-conducting lines under pressure.

In order to achieve the object cited in the introduction, the present invention further provides a method for supplying oil to tooth engagement regions and bearing arrangements of a planetary gear set, wherein the planetary gear set comprises at least a housing, a sun gear shaft which is mounted rotatably in the housing and which can be driven by means of a motor, a sun gear which is held in fixed rotative engagement on the sun gear shaft, a planet gear carrier which is mounted rotatably in the housing and on which rotatably mounted planet gears are held, wherein the planet gears engage with the sun gear, an internal gear which is arranged in positionally fixed fashion in the housing and which has an internal toothing and which engages with the planet gears, a drive output flange which is operatively connected to the planet gear carrier and which is mounted rotatably on the housing, and at least one oil supply which is designed to deliver oil to tooth engagement regions and/or bearings of the planetary gear set, characterized in that a single oil supply run of the oil supply, said oil supply run being supplied with oil via a sun gear shaft bore which extends through the sun gear shaft, supplies oil to at least a tooth engagement region between the internal gear and the planet gears, a tooth engagement region between the sun gear and the planet gears, and the bearings of the planet gears.

Further features and advantages of the present invention are illustrated by means of the following description of an embodiment of a planetary gear set according to the invention and with reference to the appended drawing, in which:

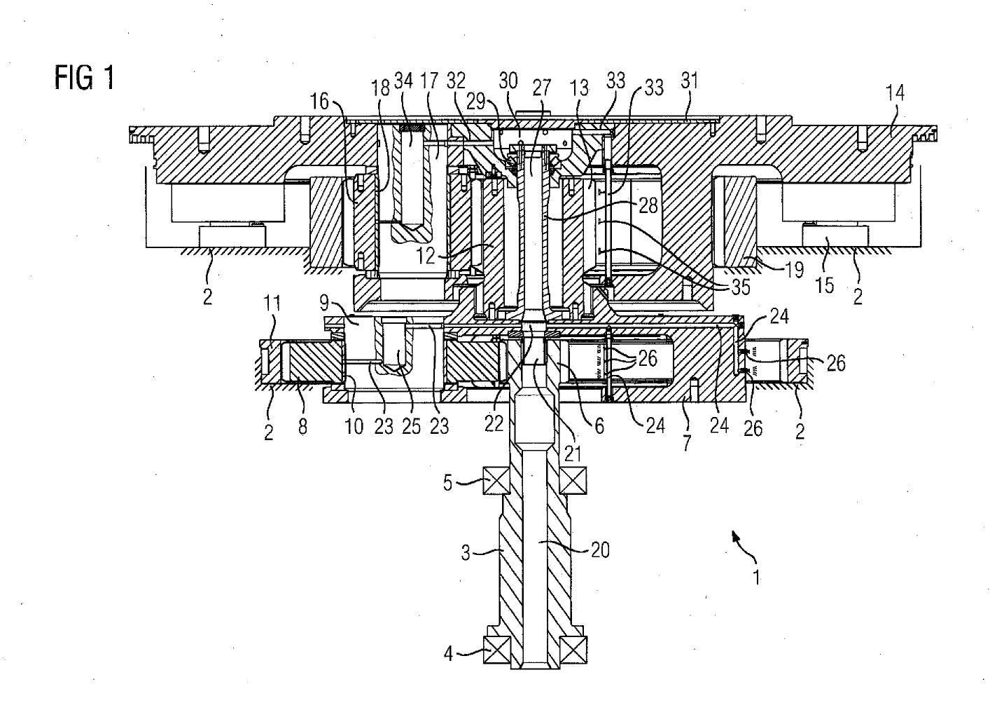

FIG. 1 shows a schematic sectional view of a planetary gear set according to an embodiment of the present invention, and

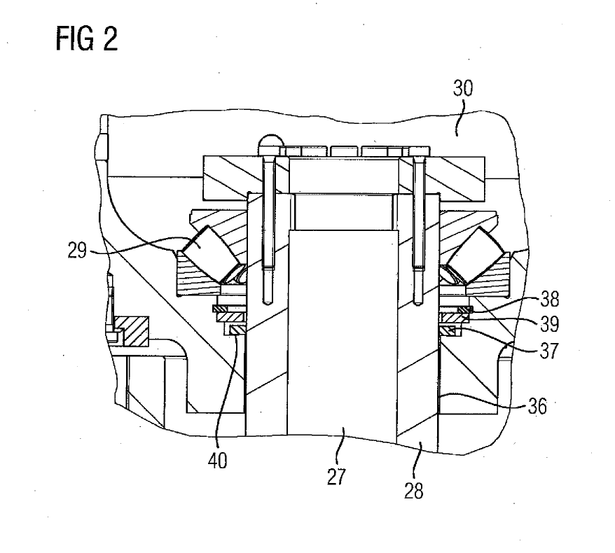

FIG. 2 shows a magnified view of the section identified by the reference sign II in FIG. 1.

The planetary gear set 1 illustrated in FIG. 1 is so designed as to have two stages, and comprises a housing 2 which is only partially illustrated for the sake of simplicity.

In order to form the first gear stage, a vertically extending sun gear shaft 3 which can be driven by a motor that is not shown in further detail is rotatably held in the housing 2 by means of corresponding bearings 4 and 5. The sun gear shaft 3 is driven directly here. Alternatively, it may also be driven indirectly, in particular via a drive shaft which leads into the side of the housing 2 and which drives the sun gear shaft 3 via corresponding bevel gears.

A sun gear 6 is installed in fixed rotative engagement in the upper region of the sun gear shaft 3. A planet gear carrier 7 is also mounted rotatably in the housing 2 and holds a plurality of planet gears 8. The attachment of the planet gears 8 to the planet gear carrier 7 is effected via fixed axles 9 which are attached to the planet gear carrier 8 and on which the planet gears 8 are held rotatably using plain bearings 10. The planet gears 8 engage with both the sun gear 6 and the internal toothing of an internal gear 11 which is held in positionally fixed fashion in the housing 2.

In order to form the second gear stage, a second sun gear shaft 12 is so arranged as to be axially aligned with the planet gear carrier 7 and attached in fixed rotative engagement thereto, wherein a second sun gear 13 is provided in fixed rotative engagement on the second sun gear shaft 12. The second sun gear shaft 12 here is designed as a hollow shaft which is integral with the second sun gear 13. A second planet gear carrier 14 which holds a plurality of second planet gears 16 is also mounted rotatably on the housing 2 using a corresponding plain bearing 15. The second planet gears 16 are held rotatably using a plain bearing 18 and correspondingly mounted on axles 17 which are fixedly connected to the second planet gear carrier 16. The second planet gears 16 engage with both the second sun gear 13 and the internal toothing of a second internal gear 19 which is held in the housing 2 in positionally fixed fashion. The top side of the second planet gear carrier 14 here forms the drive output flange, to which e.g. a grinding table of a vertical mill can be attached.

During operation of the planetary gear set 1, the sun gear shaft 3 and hence the sun gear 6 is motor-driven. The sun gear 6 drives the planet gears 8, such that these move along the internal toothing of the internal gear 11. As a result, the planet gear carrier 7 is rotationally driven, wherein the rotational speed of the planet gear carrier 7 and the rotational speed of the sun gear shaft 3 are different. The rotation of the planet gear carrier 7 is followed by the second sun gear shaft 12 and hence the second sun gear 13. The second sun gear 13 drives the second planet gears 16, which move along the internal toothing of the second internal gear 19. The second planet gear carrier 14 and hence the drive output flange which is so designed as to be integral therewith are driven thus, wherein the rotational speed of the second planet gear carrier 14 and the rotational speed of the second sun gear shaft 12 or the first planet gear carrier 7 are different.

In order to reduce the temperature and the wear of the moving gear components under load during operation of the planetary gear set 1, the planetary gear set 1 has a corresponding oil supply; This oil supply comprises a supply run which delivers the required quantity of lubricating oil to the tooth engagement regions and bearings of both gear stages. The aforementioned supply run has a sun gear shaft bore 20 which extends in the longitudinal direction of the sun gear shaft 3, a gap seal bushing 21 which is fluidically connected to the sun gear shaft bore 20, a planet gear carrier distributor 22 which is provided on the planet gear carrier 7 and which is fluidically connected to the gap seal bushing. 21, and oil-conducting lines 23 and 24 which are arranged on the planet gear carrier 7 and which are fluidically connected to the planet gear carrier distributor 22. The planet gear carrier distributor 22 and the oil-conducting lines 23 are so designed as to be at least partially integral with the planet gear carrier 7 and its axles 9 which hold the planet gears 8. More precisely, the planet gear carrier distributor 22 and a large part of the oil-conducting lines 23 and 24 are provided in the form of bores which are introduced into the planet gear carrier 7. The oil-conducting lines 23 which lead to the respective plain bearings 10 of the planet gears 8 are fluidically connected to an oil reservoir 25 in each case, wherein each oil reservoir 25 is formed by a bore which is introduced into one of the axles 9. The diameter of each oil reservoir 25 is so selected as to be greater by a multiple thereof than the diameter of the oil-conducting lines 23, in order to ensure that each oil reservoir 25 has the required storage capacity. The inlets of the oil reservoirs 25 are fluidically connected to the sun gear shaft bore 20 and are provided in the upper region of the oil reservoirs 25 in each case, and the oil outlets of the oil reservoirs 25 are fluidically connected to the respective plain bearings 10 and are provided in the lower region of the oil reservoirs 25 in each case. Therefore oil contained in the oil reservoirs 25 can only flow out of the oil reservoirs 25 under the influence of gravity in the direction of, the plain bearings 10, thereby guaranteeing the emergency running properties of the plain bearings 10. The oil-conducting lines 24 lead to the tooth engagement regions between the sun gear 6 and the planet gears 8, and between the planet gears 8 and the internal gear 11, wherein spray devices 26 whose openings are aimed in the direction of the tooth engagement regions are provided in the region of the free ends of the oil-conducting lines 24 in each case.

The aforementioned oil supply run further comprises a connection line 27 which is fluidically connected to the planet gear carrier distributor 22. The connection line 27 here is defined by a tube 28 which, at its lower free end, is fixedly connected to the second sun gear shaft 12 or to the first planet gear carrier 7 and, in the region of its upper free end, is rotatably mounted on the second planet gear carrier 14 by means of a bearing 29. The bearing 29 here is designed as a rolling bearing. However, a plain bearing may also be used as an alternative. Attached to the connection line 27 in the upward flow direction is a second planet gear carrier distributor 30 which is arranged on the second planet gear carrier 14 and in which the bearing 29 is arranged and which is sealed on its top side by a corresponding cover 31. Oil-conducting lines 32 and 33 are fluidically connected to the second planet gear carrier distributor 30, and are so designed as to be at least partially integral with the second planet gear carrier 14 and with the axles 17 holding the second planet gears 16. More precisely, the oil-conducting lines 32 and 33 are introduced into the second planet gear carrier 14 and into the axles 17 at least partially as bores. The oil-conducting lines 32 lead to the plain bearings 18 of the second planet gears 16 and are connected to an oil reservoir 34 in each case, wherein the oil reservoirs 34 in a similar fashion to the oil reservoirs 25 are designed as bores which are introduced into the axles 17 of the second planet gears 16. The oil reservoirs 34 are likewise so designed that the inlets are arranged in the upper region and the outlets in the lower region of the oil reservoirs 34 in each case, in order to guarantee the emergency running properties of the plain bearings 18 under the influence of gravity. The oil-conducting lines 33 lead to the tooth engagement region between the second sun gear 13 and the second planet gears 16, wherein spray devices 35 whose openings are aimed in the direction of the tooth engagement region are provided in the region of the free end.

During operation of the planetary gear set 1, oil is pumped into the sun gear shaft bore 20 from an oil sump which is formed in the bottom region of the housing 2. From there, the oil flows through the gap seal bushing 21 into the planet gear carrier distributor 22, from where it is distributed to the oil-conducting lines 23 and 24. The gap seal bushing 21 here forms the fluidical connection between the sun gear shaft 3 and the planet gear carrier 7, wherein these rotate at different rotational speeds. From the planet gear carrier distributor 22, the oil is distributed to the oil-conducting lines 23 and 24, in order to supply the necessary lubricating oil to both the plain bearings 18 and the previously cited tooth engagement regions. The oil reservoir 25 serves to provide a sufficient quantity of oil to guarantee emergency running properties of the plain bearings 10. Furthermore, oil flows from the planet gear carrier distributor 22 through the connection line 27 into the second planet gear carrier distributor 30, from where it is distributed to the oil-conducting lines 32 and 33 in order to supply the plain bearings 18 and the previously cited tooth engagement region. The oil reservoirs 34 here likewise serve to guarantee the emergency running properties the plain bearings 18. By virtue of the fact that the planet gear carrier 7 is held in a suspended manner, it is structurally possible to arrange the bearing 29 as illustrated within the second planet gear carrier distributor 30, whereby a separate lubricating oil supply for this bearing 29 is not required.

FIG. 2 shows a magnified view of that region of the planetary gear set 1 in which the bearing 29 is arranged. The annular gap 34 between the second planet gear carrier 14 and the tube 28 below the second planet gear carrier distributor 30 is sealed by a sealing ring 37 which is made of bronze. The sealing ring 37 can be displaced axially, wherein the freedom of movement is limited by a stop 39 which is fixed by a retaining ring 38. The sealing ring 37 is pressed with sealing effect against a shoulder 40 of the second planet gear carrier 14 by the pressure prevailing in the oil supply run, thereby minimizing the leakage through the annular gap 36.

Although the invention is illustrated and described in detail above with reference to the preferred exemplary embodiment, it is not restricted by the examples disclosed herein and other variations may be derived therefrom by a person skilled in the art without thereby departing from the scope of the invention.

What is claimed is:

1.-14. (canceled)

15. A planetary gear set, comprising:
a housing;
a first sun gear shaft mounted rotatably in the housing and driveable by a motor;
a first sun gear held in fixed rotative engagement on the first sun gear shaft;
a first planet gear carrier mounted rotatably in the housing;
first planet gears rotatably mounted on the first planet gear carrier and engaging the first sun gear;
a first internal gear arranged in positionally fixed fashion in the housing and having an internal toothing in engagement with the first planet gears;
a drive output flange operatively connected to the first planet gear carrier and mounted rotatably on the housing; and
at least one oil supply configured to deliver oil to tooth engagement regions and bearings, said oil supply comprising
a sun gear shaft bore extending in a longitudinal direction of the first sun gear shaft,
a gap seal bushing fluidically connected to the sun gear shaft bore,
a first planet gear carrier distributor fluidically connected to the gap seal bushing and provided on the first planet gear carrier,
a first oil reservoir; and
first oil-conducting lines arranged on the first planet gear carrier and fluidically connected to the first planet gear carrier distributor, said first oil-conducting lines configured to lead to the tooth engagement regions and at least to bearings of the first planet gears, each of the first oil-conducting lines leading to the bearings of the first planet gears being connected to the first oil reservoir to ensure emergency running properties of the bearings.

16. The planetary gear set of claim 15, wherein the first oil-conducting lines lead from the first planet gear carrier distributor at least to a tooth engagement region between the first internal gear and the first planet gears, to a tooth engagement region between the first sun gear and the first planet gears, to a bearing of the first planet gear carrier, and to the bearings of the first planet gears.

17. The planetary gear set of claim 15, wherein at least one member selected from the group consisting of the first planet gear carrier distributor and at least some of the first oil-conducting lines is configured integral with the first planet gear carrier.

18. The planetary gear set of claim 17, wherein the first planet gear carrier has a bore to form the member.

19. The planetary gear set of claim 15, wherein the first oil reservoir is provided in the form of a bore defined by a diameter which is greater than a diameter of the first oil-conducting lines.

20. The planetary gear set of claim 15, wherein the drive output flange is connected in fixed rotative engagement to the first planet gear carrier.

21. The planetary gear set of claim 15, wherein the drive output flange is formed by the first planet gear carrier.

22. The planetary gear set of claim 15, constructed as a multi-stage planetary gear set comprising a second sun gear shaft connected in fixed rotative engagement to the planet gear carrier, a second sun gear held in fixed rotative engagement on the second sun gear shaft, a second planet gear carrier mounted rotatably in the housing, second planet gears rotatably mounted on the second planet gear carrier and engaging the second sun gear, a second internal gear arranged in positionally fixed fashion in the housing and having an internal toothing in engagement with the second planet gears of the second planet gear carrier, said drive output flange being connected in fixed rotative engagement to the second planet gear carrier or being formed by the second planet gear carrier, said oil supply comprising a connection line fluidically connected to the planet gear carrier distributor provided on the first planet gear carrier, a second planet gear carrier distributor fluidically connected to the connection line and arranged on the second planet gear carrier, and second oil-conducting lines arranged on the second planet gear carrier and fluidically connected to the second planet gear carrier distributor, said second oil-conducting lines leading to tooth engagement regions and/or bearings.

23. The planetary gear set of claim 22, wherein the second oil-conducting lines lead from the second planet gear carrier distributor at least to a tooth engagement region between the second internal gear and the second planet gears, to a tooth engagement region between the second sun gear and the second planet gears, and to bearings of the second planet gears.

24. The planetary gear set of claim 23, wherein each of the second oil-conducting lines leading to the bearings of the second planet gears is connected to a second oil reservoir which is provided in the form of a bore defined by a diameter which is greater than a diameter of the second oil-conducting lines.

25. The planetary gear set of claim 22, wherein at least one member selected from the group consisting of the second planet gear carrier distributor and at least some of the second oil-conducting lines is configured integral with the second planet gear carrier.

26. The planetary gear set of claim 25, wherein the second planet gear carrier has a bore to form the member.

27. The planetary gear set of claim 22, wherein the second sun gear shaft has a hollow configuration, said connection line being configured as a tube which is guided through the second sun gear shaft and is rotatably mounted on the second planet gear carrier by a bearing.

28. The planetary gear set of claim 27, wherein the bearing is arranged within the second planet gear carrier distributor.

29. The planetary gear set of claim 27, further comprising a sealing ring configured to seal an annular gap below the bearing between the tube and the second planet gear carrier and held on the tube.

30. The planetary gear set of claim 29, wherein the sealing ring is made of bronze.

31. The planetary gear set of claim 22, further comprising spray devices arranged at a free end of the first and second oil-conducting lines leading to the tooth engagement regions.

32. A method for supplying oil to tooth engagement regions and bearing arrangements of a planetary gear set having a rotatable sun gear shaft driveable by a motor, said method comprising supplying oil through a single oil supply run via a sun gear shaft bore extending through the sun gear shaft to at least a tooth engagement region between an internal gear and planet gears of the planetary gear set, to a tooth engagement region between a sun gear of the planetary gear set and the planet gears, and bearings of the planet gears.
